(19) United States
(12) Patent Application Publication
(10) Pub. No.: US 2014/0218943 A1
(43) Pub. Date: Aug. 7, 2014

(54) ALUMINUM PRINTED CIRCUIT BOARD FOR LIGHTING AND DISPLAY BACKPLANES

(71) Applicant: William R. Freeman, Gilroy, CA (US)

(72) Inventor: William R. Freeman, Gilroy, CA (US)

(73) Assignee: CRYSTALPLEX CORPORATION, Pittsburgh, PA (US)

(21) Appl. No.: 14/171,194

(22) Filed: Feb. 3, 2014

Related U.S. Application Data
(60) Provisional application No. 61/759,845, filed on Feb. 1, 2013.

(51) Int. Cl. F21V 29/00; F21K 99/00

(52) U.S. Cl. CPC F21V 29/22; F21K 9/30
USPC 362/382

(57) ABSTRACT

Disclosed herein are metal printed circuit boards, particularly aluminum based printed circuit boards. Also disclosed are methods of making the metal printed circuit boards. Also disclosed are lighting systems, such as LED lighting systems, employing the disclosed metal printed circuit boards.

### CROSS REFERENCE TO RELATED APPLICATION

This application claims benefit of priority to U.S. Provisional Patent Application No. 61/759,845 entitled ALUMINUM PRINTED CIRCUIT BOARD FOR LIGHTING AND DISPLAY BACKPLANES and filed on Feb. 1, 2013, which is hereby incorporated by reference in its entirety.

### BACKGROUND

Lighting and display applications that use LEDs or other forms of solid state lighting are not 100% efficient (electrical to optical efficiency) and thus generate heat. At the present time, even 50% efficiency is a difficult target, implying the generation of a lot of heat. Most solid state lighting devices will be more efficient and function longer if kept cooler. An ordinary epoxy glass board will have a thermal conductivity (TC) of less than 1 W/m-K (Watts per meter per degree Kelvin or Centigrade). The higher that thermal conductivity, the lower the temperature differential needs to be to dissipate a given amount of power. Applicants have found that a metal-based PCB improves this heat dissipation to achieve greater efficiency and may improve service life.

### BRIEF DESCRIPTION OF THE DRAWINGS

FIG. 1 is a cross-sectional view of a metal PCB in accordance with some embodiments.

FIG. 2 is a cross-sectional view of an LED lighting display in accordance with some embodiments.

### DETAILED DESCRIPTION

As ordinary epoxy glass, PCB has a thermal conductivity (TC) of about 1 W/m-K (the units will be understood in what follows). Aluminum has a TC of more than 200 and alumina (aluminum oxide ceramic created by oxidizing aluminum metal) has a TC greater than 24. A PCB is typically 62 mils thick (one mil=0.001 inches or 25.4 um), making the minimum distance the heat has to travel about 1545 um (62 mils×25.4 um/mil). The power dissipation for a given configuration is P=A·Tc·ΔT/Z (where A is the area of the material conducting the heat, Tc is the TC, ΔT is the temperature differential, and Z is the thickness of the conducting material). Assuming that the areas of the conducting surfaces are the same, an aluminum PCB arrangement has two favorable aspects. The thickness of the dielectric layer is less than about 50 um, making the power dissipation capability more than 30 times that of the PCB. The TC of this layer is more than 20 times greater than an epoxy glass based PCB. So at a minimum this technology can increase the power dissipation or correspondingly (see the equation above) decrease the temperature differential required for a given power dissipation by at least about 600 fold.

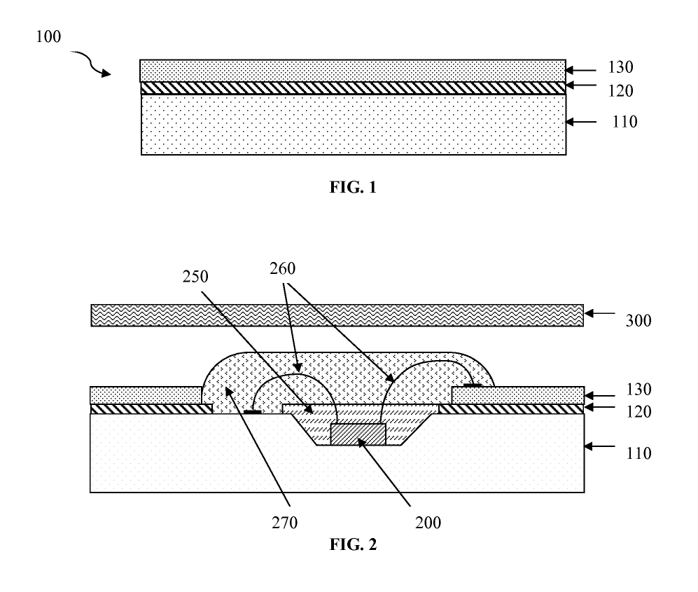

FIG. 1 illustrates the concept of a metal PCB 100. The base 110 of the PCB 100 is metal of thickness sufficient to conduct the heat away at a specified temperature differential (ΔT). Generally, the metal layer is the thickest of all layers. This layer acts as a heat sink. The base 110 is patterned (by lithography, screen printing, etc.) and covered by a dielectric 120, the dielectric is patterned and metalized 130. This process can be repeated for a number of layers. While in principle this process could be repeated indefinitely, in some embodiments the PCB has 3 to 10 layers, in some embodiments 6 to 8 layers, in some embodiments 3 to 7 layers, and in some embodiments 3 to 6 layers. In some embodiments, the PCB has three layers, four layers, five layers, six layers, seven layers, or eight layers, or any value or range of values between any of these values.

Some embodiments include a method comprising:
screen printing on a mask;
anodizing the aluminum with a rather thick layer (70 um to 80 um) of anodization to form a dielectric layer;
patterning the anodized layer exposing the areas where traces and pads will later be located;
zincating in preparation for electroless nickel (EN) deposition. The zincation step requires that the nitric acid etch is either eliminated or made less aggressive so that it does not remove significant amounts of the anodized dielectric layer. The zincate treatment itself removes some anodization (about 40 um), which was the motivation for the excessively thick initial anodized layer; and
EN plate deposition to desired thickness.

There are many variations on this theme. For example, the EN layer can be made continuous so that later a new mask can be used to expose only the areas to be plated up and later after stripping the mask etch off the unwanted connecting field metal. Another possibility is to skip the whole EN step altogether and use a photo-catalytic decomposition process to produce a strike layer. For example, the anodized plate could be placed in a copper formate bath and laser write the desired pattern.

The metal substrate may be any suitable metal. Aluminum and titanium both anodize well, and are particularly well suited for this use. Nevertheless, other metals may be used by producing a dielectric layer by techniques other than anodizing. In the case of many metals including aluminum, a batch nitriding process can produce a dielectric layer that can then be further processed. The improved dissipation of those metal PCBs are well-suited for LED light displays.

Up to ⅓ of the light from an LED die is emitted from the sides. This light is frequently poorly captured by standard LED packages. The metal PCB structure described herein can be modified to capture and emit much of this lost light emission.

As seen in FIG. 2, metal PCB substrate 110 (heatsink) is being used as common anode or cathode. In this arrangement, the LEDs, or groups of LEDs, can be run in parallel.

The LED die 200 may also be chip on carrier or any other form of packaging that does not significantly obstruct extraction of the side emitted light (meaning light that is emitted from the edges of the LED chip). As shown in FIG. 2, the metal layer 110 of the PCB defines a well which dips below the surface of the metal layer. An LED chip is secured at the bottom o fthe well and operatively coupled to the metalized layer 130 and the metal layer 110. The well generally has sloped or curved sidewalls 112 to extract LED edge light and reflect it away from the PCB, thus increasing light output. In some embodiments, the light extracted from the LED edge is then reflected toward an optional QD quantum dot conversion film 300 by the sloped walls. The walls are shown as straight, but they could be curved in a way to make the reflected light highly directional. In some embodiments, the well could have a parabolic or other shape designed to reflect and/or focus the light. Importantly, because the LED chip is in direct contact with the metal layer, heat is quickly conducted away from the LED, leading to cooler operating conditions.

The light coming out the side of the LED is efficiently extracted into a nano-particle filled polymer matrix 250 (e.g., titanium oxide nano-particles in silicone, where the concentration is adjusted to give the best refractive index for light extraction from the LED), reflected upward by the sides of the well the LED resides in, and is indexed matched to air by the polymer matrix 250 that protects the wire bonds 260. This may achieve up to 20% to 25% more useful light out of the LED. Some of the side emitted light will be useful even if nothing is done to extract or redirect it. This arrangement is useful for LED die and chip on carrier packages where the packages do not block the sides of the LED in ways that make efficient light extraction difficult or impossible. The LED may also be provided with a protective polymeric lens 270.

The QD conversion film comprises a plurality of quantum dots which may further improve the performance or alter the qualities of the light produced by the LED.

Although this description focuses on aluminum as the substrate, many other metals and alloys can be used at each step (list them). Aluminum is well-suited because it has many desirable characteristics such as weight, TC, anodizability, etc. Solution processing, while inexpensive and relatively easy, is a preferred technique, but is by no means the only technique available for laying down dielectric and traces. In a volume production environment, vacuum deposition techniques may be used and in some instances can be low cost.

Some advantages of some embodiments is that they solve thermal management and light extraction with a simple low cost, highly manufacturable solution.

Currently, high thermal conductivity PCBs are metal core boards which are quite expensive and not nearly as effective as a true metallic PCB. The reason that this technology has not been developed previously is that the development thrust in PCB technology has been toward smaller and faster. This technique described herein is not likely to give as fine a feature as the better PCB processes can achieve. These boards may be slow because of the large distributed capacitance due the high dielectric constant of alumina (about 25) and the mere 40 um or so of dielectric thickness. However, with the advent of LED lighting there is an opportunity for this technology to move into the spotlight in a high volume way.

At the heart of it, the basic aluminum PCB invention is replacing what would normally be done by expensive physical vapor deposition PVD, chemical vapor deposition CVD, etc. processes, with much less expensive solution processing.

The major differences between this approach to thermal management and the currently popular metal core PCBs is:

A tradeoff of high speed (low K dielectrics, etc.), fine pitch (close spacing of fine traces—1 mil traces on a 2 mil spacing) has been made for superior thermal performance.

The cost has been minimized by choosing inexpensive high volume techniques. The techniques are based on batch solution processing and additive processes. [Recall that PCBs are generally based on subtractive technology, meaning that copper is removed instead of added.]

Although in principle, these techniques can be used to build multilayer boards, most likely two layer boards will dominate for lighting applications and 4 to 8 layer boards for display applications.

There are no organic compounds in the final product meaning that subsequent processing will be more thermally tolerant than epoxy-glass PCBs.

What these metal PCBs may lack when compared to their contemporaries is made up by improved light extraction in solid state lighting. Efficient light extraction is critically important to making efficient LED lighting. With every bit of added efficiency either the efficiency of the LED goes up because they can be run at a lower current (LED efficiency degrades significantly as the current is increased) or the cost of the light goes down because less LEDs are required for a given light output. Either way, coupling a metal PCB to an LED or LED array achieves significant gains in LED efficiency.

The concept originated from using batch nitriding to produce the dielectric layer. Then the idea of the metal PCB was discussed. After considerable investigation we started investigating anodizing as a better alternative to nitriding. Incidentally, the motivation for considering nitriding before anodizing was largely driven by the fact that aluminum nitride has a TC around 200, so is nearly as good a thermal conductor as aluminum itself, while aluminum oxide (alumina) has a TC around 25. So there is an 8× penalty for going to anodizing. The fact is that dielectric films are so thin that it does not make enough difference in the LED operating temperature to have significant effect on the efficiency.

What is claimed is:

1. A printed circuit board for solid state lighting comprising:
a printed circuit deposited directly on a heat sink.

2. at least one Light Emitting Diode (LED) wired directly to the printed circuit, wherein the LED is in direct contact with the heat sink.

3. The printed circuit board of claim 2, wherein the LED is not a prepackaged LED.

4. The printed circuit board of claim 2 further comprising wells in the heat sink within which the LED is placed.

5. The printed circuit board of claim 4, further comprising an insulation layer between the heat sink and the printed circuit.

6. The printed circuit board of claim 1, wherein no external heat sink is provided.

7. The printed circuit board of claim 2 comprising a plurality of LEDs.

8. The printed circuit board of claim 1, wherein the heat sink is metal.

9. The printed circuit board of claim 1, wherein the heat sink is aluminum.

8. A lighting display comprising:
a printed circuit deposited directly on a heat sink;
at least one Light Emitting Diode (LED) wired directly to the printed circuit, wherein the LED is in direct contact with the heat sink.

8. The lighting display of claim 7, wherein the at least one LED comprises a plurality of LEDs.
